(19) United States
(12) Patent Application Publication
(10) Pub. No.: US 2025/0035483 A1
(43) Pub. Date: Jan. 30, 2025

(54) APPARATUS, SYSTEM AND METHOD FOR USE IN COMMERCIAL AND INDUSTRIAL WASTE MANAGEMENT

(71) Applicant: WASTE CHECK AUSTRALIA PTY LTD, Port Melbourne, VIC (AU)

(72) Inventors: Alex NORTHEY, Port Melbourne, VIC (AU); Solomon JONES, Port Melbourne, VIC (AU)

(73) Assignee: WASTE CHECK AUSTRALIA PTY LTD, Port Melbourne, VIC (AU)

(21) Appl. No.: 18/713,967

(22) PCT Filed: Nov. 27, 2022
(86) PCT No.: PCT/AU2022/051421

§ 371 Date: May 28, 2024

(30) Foreign Application Priority Data
Nov. 26, 2021 (AU) 2021903839
Dec. 3, 2021 (AU) 2021903928

(51) Int. Cl. G01G 19/52; B65F 1/14; B65F 1/16; G01G 3/14

(52) U.S. Cl. CPC G01G 19/52; B65F 1/1473; B65F 1/1615; G01G 3/14; B65F 2210/128; B65F 2210/138; B65F 2210/168; B65F 2210/184

(57) ABSTRACT

An apparatus, system and method for detecting and managing data relating to a weight of a waste bin (including a recycling bin) comprising a plurality of load cells rigidly retained, in use, relative to the waste bin by one or more retaining means; wherein the apparatus is configured and dimensioned such that, in use, a portion of the bin is disposed substantially above, and bears down on, each of the plurality of load cells; and wherein the apparatus is configured to, in use, be communicable with means for recording and transmitting data from the plurality of load cells. The system further comprises the means for recording and transmitting the data from the plurality of load cells and a receiver for receiving data transmitted from said means, said receiver being communicable with, or integrated with, an electronic device of at least one prespecified recipient, to enable the transmitted data to be displayed to said at least one prespecified recipient. The method comprises at predetermined recording intervals, recording data from the plurality of load cells; at predetermined transmission intervals, transmitting the recorded data to the receiver; and then displaying the transmitted data on the electronic device of the at least one prespecified recipient.

### FIELD OF THE INVENTION

The present invention relates to an apparatus, system and method for use in commercial and industrial waste management. The invention has particular application to commercial and industrial size waste bins, but may also have other applications.

### BACKGROUND

Commercial and industrial waste management is a process involving multiple parties. There is, firstly, the building or premises (such as a business, office building, manufacturing facility, warehouse, education facility, medical facility, aged care facility, hotel, restaurant, sporting club, shopping centre, apartment building, et cetera—the “premises”) at which waste is accumulated, typically in a commercial or industrial-size waste bin which can have a capacity of, for example, around 80 L to 6000 L.

Then there is the waste management supplier (WMS), being the party that collects waste from the premises by emptying the commercial and industrial waste bins (typically into a waste or recycling truck) on a regular basis. Lastly, there is the landfill provider or material recovery facility (“MRF”), being the recipient of the collected waste for subsequent processing (in some cases the WMS themselves may also be the recipient of the waste, which they process and on-sell).

In practical terms, it is the norm for the WMS to provide the premises with a cost estimate per load collection, i.e. per bin-emptying, on a “forecasted density” basis based on the premises type and the volume of the bin: premises such as hairdressers can generally be expected to deposit low-density waste (hair etc) into the bin, while premises such as restaurants can generally be expected to deposit high-density waste (food scraps etc). From this, a “forecasted” weight of a given bin can be estimated.

However, the landfill provider or MRF charges the WMS based on the actual weight (i.e. mass) of the waste or recycling material being delivered.

Thus, there can often be a discrepancy between the amount the WMS has charged the premises and the amount the landfill provider or MRF then charges the WMS. If the latter is greater than the former, the WMS must either wear the extra cost or seek to revise its quote to the premises or recoup the difference from them, often in the form of an excess weight charge.

A further problem resulting from the “forecasted density” approach is that the WMS cannot predict with accuracy when exactly in its “run” a given waste or recycling truck will become full. The WMS can predict the approximate load expected from each waste bin the truck is due to empty—but in reality the bins may be heavier or lighter than predicted, meaning the truck may reach capacity (referred to as “maximum gross vehicle mass”) and need to proceed to the landfill provider/MRF earlier (or later) than planned, which will impact its route and potentially require alternate arrangements to be made for servicing of certain premises. This uncertainty is a significant impediment to the WMS' ability to accurately plan/roster/optimize the operation/scheduling of its fleet of trucks.

The reason for the “forecasted density” approach the WMS is forced to take is that it is impracticable for bins to be effectively weighed by the WMS to determine their actual weight. While “truck-mounted” weighing technology for waste or recycling trucks exists, it is very expensive to install and thus is not widely implemented. Also, such technology tends to be relatively inaccurate and unreliable in the weight readings it gives. It also only weighs the bin at the point of collection, which is usually after the WMS has given the premises its cost estimate per service.

Some providers offer technology whereby the bin is rolled/slid onto a customized platform scale prior to collection. However, such platform scales have dimensional limitations which mean they tend to only be suitable for bins up to approximately the 1100 L size—i.e. at the smaller end of commercial or industrial-size bins. Furthermore, this approach is obviously time-consuming and labour-intensive as the bins must be physically manoeuvred onto (and then off of) the scale: if this is not done, the weight reading is not recorded on that occasion.

While of course load-weighing technologies exist in various materials-processing contexts, these are unsuitable for use in a commercial waste management application. Generally speaking such technologies are designed for small-scale loads, must account for torque and thus require expensive and sophisticated load cell design and/or processing of data, and/or require elaborate mounting structures and particular load placement relative to the cells and/or mounting structures. Such technologies are therefore not implementable in a commercial and industrial waste management context, due to the size of the load, restrictions on expense, and unpredictability of load distribution within the bin.

As a consequence of these issues, WMS providers are generally unable to detect the actual weight of a given bin prior to collection, and must therefore base their quote to the premises on an estimate, namely using the “forecasted density” approach. This has the drawbacks discussed above-namely, discrepancies between the WMS' quote and the amount actually charged by the landfill provider/MRF: and the inability for the WMS to accurately/efficiently plan the scheduling/routing of its waste or recycling trucks ahead of time.

A further problem is that current commercial and industrial waste management processes are somewhat “crude” in their implementation, that is to say they are not particularly efficient and the parties to them tend to not be “in sync” with each other and not fully informed/engaged in the process or able to access the relevant data. In these increasingly environmentally-conscious times, this is problematic for commercial and industrial entities seeking to dispose of waste in an optimal and environmentally-friendly manner, as well as for WMS providers likewise seeking to be environmentally conscious. To a large extent this ties in with the first problem, since government agencies are increasingly implementing incentives for an empirical approach to be taken to waste-disposal (such as Australia's NABERS protocol and the Australian Carbon Credit Units programme)—so facilitating weighing of waste is more than just a costing issue, it is also a matter of alignment with environmental incentives/policies. Currently, most premises, particularly commercial and industrial premises, are largely guessing at (or estimating) their waste accumulation tendencies, which is hardly conducive to compliance with said incentives/policies.

It is accordingly an object of the present invention to provide a system that ameliorates one or more of the above-noted problems with the prior art. At the very least, it is an object of the invention to provide the public with a useful choice.

### DEFINITIONS/TERMINOLOGY

In this specification, the following terms should be understood as follows:
Premises means the premises at which the waste bin is located in use-such as, without limitation, a business, office building, manufacturing facility, warehouse, education facility, medical facility, aged care facility, hotel, restaurant, sporting club, shopping centre, club, apartment building, et cetera.
Waste means any refuse material that is deposited into a waste bin or receptacle, including, without limitation, food organics, paper and cardboard, recycling, commingle (mixed recycling), general waste, e-cycle (e-waste), shredded paper, et cetera.
Waste bin accordingly means a bin configured to receive any of the above-noted (or other) types of waste—and notably includes a recycling bin.
Weight of the waste bin is inclusive of the contents of the waste bin at any given point in time.

### STATEMENTS OF THE INVENTION

According to one aspect of the invention, there is provided an apparatus configured to, in use, detect a weight of a waste bin, the apparatus comprising:
a plurality of load cells rigidly retained, in use, relative to the waste bin by one or more retaining means,
wherein the apparatus is configured and dimensioned such that, in use, a portion of the bin is disposed substantially above, and bears down on, each of the plurality of load cells;
and wherein the apparatus is configured to, in use, be communicable with means for recording and transmitting data from the plurality of load cells.

Preferably, said retaining means is provided by a frame, said plurality of load cells being rigidly connected, in use, to the frame, said frame being configured and dimensioned such that, in use, a portion of the bin is disposed substantially above, and bears down on, each of the plurality of load cells.

Alternatively, said retaining means is provided by a base plate, said plurality of load cells being rigidly connected, in use, to the base plate, said base plate being configured and dimensioned such that, in use, a portion of the bin is disposed substantially above, and bears down on, each of the plurality of load cells.

Preferably, the base plate has one or more apertures or perforations, such as proximate a centre of the base plate, to allow egress of fluid or other material from a top surface of the base plate.

Preferably, a portion(s) of the base plate has a downward slope towards said one or more apertures or perforations, to encourage said egress of fluid or other material.

Alternatively, said retaining means is provided by fastening means associated with each of the plurality of load cells and configured to, in use, rigidly connect said load cells to the base of the bin.

Preferably, said fastening means are provided by bolts. However, this is not intended to be limiting and other fastening means may be used.

Preferably, the fastening means are used in conjunction with upper and lower plates as described below, wherein the upper plate is connected via the fastening means to the base of the bin.

The following subsidiary Statements of Invention are, for sake of convenience, construed in terms of the retaining means being provided by a frame. However, it will be understood that certain of the subsidiary Statements of Invention may, with appropriate modification, also apply where the retaining means is instead provided by a base plate. Furthermore, certain of the subsidiary Statements of Invention may, with appropriate modification, also apply where the retaining means is instead provided fastening means associated with each of the plurality of load cells.

Preferably, a portion of the bin is disposed directly above each of the plurality of load cells.

Preferably, the frame is substantially square or rectangular.

Preferably, the frame is configured and dimensioned to be dimensionally substantially complementary to a base of the waste bin.

Preferably, the frame has a substantially L-shaped cross-section comprising a sidewall portion extending substantially vertically and a horizontal portion extending inwardly from a lower edge of the sidewall portion.

Preferably, the plurality of load cells are spaced, in use, substantially regularly relative to the frame.

More preferably, the plurality of load cells are disposed, in use, at the corners of the frame.

Preferably the plurality of load cells are rigidly connected, directly or indirectly, to the horizontal portion of the frame.

Preferably, each of the plurality of load cells is associated with a lower plate connected to a lower end of the load cell and configured to, in use, be rigidly connected to the frame.

Preferably, each of the plurality of load cells is associated with an upper plate connected to an upper end of the load cell and configured to, in use, support a portion of the bin.

Preferably, the upper plate is configured to, in use, be connected to the base of the bin.

Preferably, the load cells are strain gauge load cells. More preferably, the load cells are S-type load cells. Alternatively, the load cells may be hydraulic or pneumatic load cells, or other types of load cells.

Preferably, each of the plurality of load cells is configured such that, in use, the upper end of the load cell extends above the frame, to enable deformation of the load cell under loading in use.

Preferably, each of the plurality of load cells is, in use, associated with limiting means configured to prevent the load cell from being subjected to excessive deformation.

More preferably, the limiting means is provided by a limit member assembly comprising an upper limit member and a lower limit member, wherein, in use, the upper and lower limit member are arranged such that a gap between them defines a maximum deformation of the load cell.

Preferably, the upper limit member is associated with the upper plate and the lower limit member is associated with the lower plate.

Preferably, each of the plurality of load cells is associated with at least two limit member assemblies, disposed substantially symmetrically in relation to the load cell.

Preferably, the upper limit member and the lower limit member are provided, respectively, by an upper limit bolt and a lower limit bolt.

Preferably, the apparatus is configured to, in use, be integrated with a wheeled bin.

More preferably, the apparatus is configured to, in use, be fitted between the base of the bin and wheels of the bin.

Even more preferably, the lower plates of the apparatus are configured to, in use, be connected to mounting plates of the wheels or wheel castors.

Preferably, the data from the plurality of load cells comprises data relating to an applied load to which each load cell is subjected in use.

Preferably, the means for recording and transmitting data is configured to record the data at predetermined recording intervals, and to transmit the recorded data at predetermined transmission intervals.

Preferably, the predetermined recording intervals and/or predetermined transmission intervals are selectively alterable by a user.

Preferably, the predetermined recording intervals are between substantially every 1 minute to substantially every 24 hours: more preferably substantially every 1 hour; and even more preferably substantially every 5 minutes.

Preferably, the predetermined transmission intervals are between substantially every 1 hour to substantially once per week: and more preferably substantially every 24 hours.

Preferably, the means for recording and transmitting data is configured to transmit the recorded data to a receiver.

Preferably, the receiver is communicable with, or integrated with, an electronic device of at least one prespecified recipient of the transmitted data, to enable the transmitted data to be displayed to said at least one prespecified recipient.

Preferably, said at least one prespecified recipient is a party associated with a premises on which the waste bin is located in use, such as a building operations manager.

Preferably, a further prespecified recipient is a waste management supplier tasked with collecting and/or emptying the waste bin.

Preferably, the apparatus includes the means for recording and transmitting data from the plurality of load cells.

Preferably, the means for recording and transmitting data from the plurality of load cells is connected, in use, to the frame.

Preferably, the waste bin is a commercial or industrial-size waste bin.

Preferably, the waste bin is a rear end lift bin or front end lift bin.

Preferably, the waste bin has a capacity (i.e. volume to which it is designed to be filled) of substantially 80 L-6000 L. More preferably, the waste bin has a capacity of one of: 80 L; 120 L: 240 L: 360 L; 660 L; 1000 L (1 m³): 1100L (1.1m3): 1500 L (1.5 m³): 2000 L (2 m³): 3000 L (3 m³): 4500 L (4.5 m³): or 6000 L (6 m³).

Preferably, the waste bin is fitted with a lock such that only authorized parties (possessing a key) have access to, and are able to deposit matter into, the waste bin.

Preferably, the lock and the key are fitted with, or otherwise associated with, identification means, such as RFID or keypad technology, such that each “deposit event” can be tracked to a particular authorized party.

According to another aspect of the invention, there is provided a system for detecting and managing data relating to a weight of a waste bin, the system comprising:
an apparatus for detecting the weight of the waste bin, said apparatus comprising a plurality of load cells rigidly retained, in use, relative to the waste bin by one or more retaining means: wherein the apparatus is configured and dimensioned such that, in use, a portion of the bin is disposed substantially above, and bears down on, each of the plurality of load cells:
means for recording and transmitting data from the plurality of load cells of said apparatus, wherein said apparatus is configured to, in use, be communicable with said means: and
a receiver for receiving data transmitted from said means, said receiver being communicable with, or integrated with, an electronic device of at least one prespecified recipient, to enable the transmitted data to be displayed to said at least one prespecified recipient.

Preferably, the apparatus, the means for recording and transmitting data from the plurality of load cells of the apparatus, and receiver for receiving data transmitted from said means, are substantially as described above.

According to another aspect of the invention, there is provided a method of detecting and managing data relating to a weight of a waste bin, using:
an apparatus for detecting the weight of the waste bin, said apparatus comprising a plurality of load cells rigidly retained, in use, relative to the waste bin by one or more retaining means: wherein the apparatus is configured and dimensioned such that, in use, a portion of the bin is disposed substantially above, and bears down on, each of the plurality of load cells:
means for recording and transmitting data from the plurality of load cells of said apparatus, wherein said apparatus is configured to, in use, be communicable with said means: and
a receiver for receiving data transmitted from said means, said receiver being communicable with, or integrated with, an electronic device of at least one prespecified recipient, to enable the transmitted data to be displayed to said at least one prespecified recipient,
   the method comprising the steps of:
at predetermined recording intervals, recording data from the plurality of load cells:
at predetermined transmission intervals, transmitting the recorded data to the receiver:
displaying the transmitted data on the electronic device of the at least one prespecified recipient.

Preferably, the apparatus, the means for recording and transmitting data from the plurality of load cells of the apparatus, and the receiver for receiving data transmitted from said means, are substantially as described above.

Preferably, the predetermined recording intervals and/or predetermined transmission intervals are selectively alterable by a user.

Preferably, the predetermined recording intervals are between substantially every 1 minute to substantially every 24 hours: more preferably substantially every 1 hour: and even more preferably substantially every 5 minutes.

Preferably, the predetermined transmission intervals are between substantially every 1 hour to substantially once per week: and more preferably substantially every 24 hours.

Preferably, said at least one prespecified recipient is a party associated with a premises on which the waste bin is located in use, such as a building operations manager.

Preferably, a further prespecified recipient is a waste management supplier tasked with collecting and/or emptying the waste bin.

The present invention provides a number of optional advantages over the prior art, including, in some embodiments, providing an apparatus, system and method that:
provides a simple and cost-effective apparatus that can be adapted to suit varying waste bin sizes/dimensions/types:
provides an apparatus that delivers high-accuracy weight readings:
enables waste bin weight to be automatically recorded and transmitted at predetermined time intervals, with no additional weighing steps or third-party involvement required:
thereby enables all relevant parties to have ongoing and up-to-date access to bin weight data, including for instance the building operations manager and the waste management supplier, but also for instance governmental, environmental, or regulatory/oversight bodies:
enables the building operations manager to monitor waste disposal more accurately and in greater detail;
also enables the building operations manager (or other premises) to obtain real-time data relating to their waste accumulation, and thus make more informed and empirical decisions relating to the environment, and to various related initiatives such as net carbon zero targets:
also enables the waste management supplier to provide more accurate waste disposal cost estimates to the building operations manager, based on actual weight detected by the system as opposed to “forecasted density”:
also enables the waste management supplier to know, ahead of time, the weight of each load to be picked up by their waste truck(s), thereby enabling them to more efficiently and accurately plan their fleet's route/rostering/pickup schedule:
also enables the waste management supplier to know, ahead of time, how much of each type of waste they have, such that they can predict any profits associated with each type of waste based on weight:
Enables both the building operations manager and the waste management supplier to detect when a waste bin is actually full (or nearly full), thereby enabling both parties to more efficiently manage/schedule waste bin servicing.
Facilitates compliance by all relevant parties with applicable environmental incentives/policies/regulations.

At the very least, the present invention provides the public with a useful choice.

### BRIEF DESCRIPTION OF FIGURES

Further aspects and advantages of the invention will become apparent with reference to the accompanying Figures, which are given by way of example only and in which:

FIG. 1 shows the apparatus according to one preferred exemplary embodiment of the invention connected to a waste bin;

FIG. 2 shows the apparatus of FIG. 1 viewed upside down;

FIG. 3 is a close-up view of one of the wheel portions of the apparatus of FIG. 1:

FIG. 4 shows the apparatus of FIG. 1 disconnected from the bin but connected to the wheels:

FIG. 5 is a close-up view of one of the load cells of the apparatus of FIG. 4;

FIGS. 6A & 6B are schematics showing a load cell similar to that of the apparatus of FIG. 1:

FIG. 7 shows the means for recording and transmitting data according to a another preferred exemplary embodiment of the present invention: and

FIG. 8 shows transmitted data being displayed on an electronic device of a prespecified recipient according to another preferred exemplary embodiment of the present invention.

### DETAILED DESCRIPTION OF FIGURES

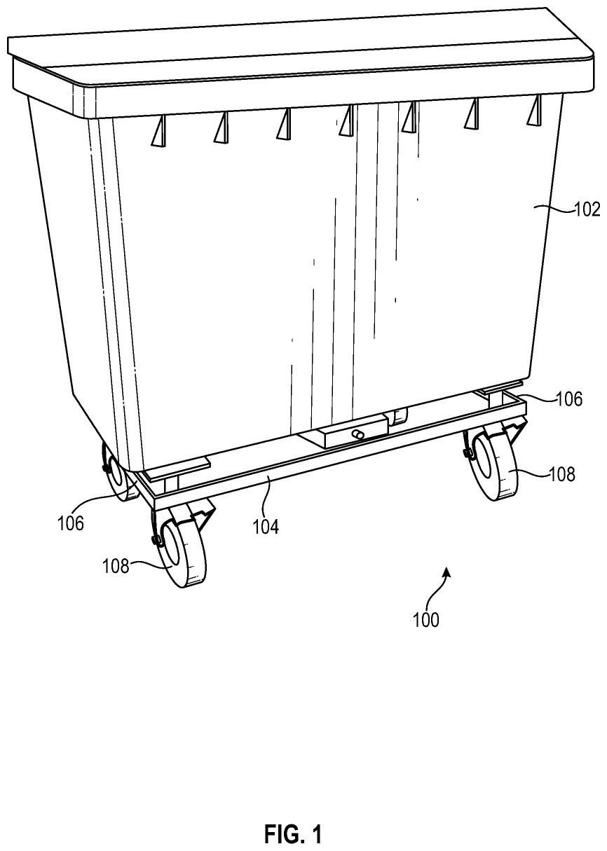

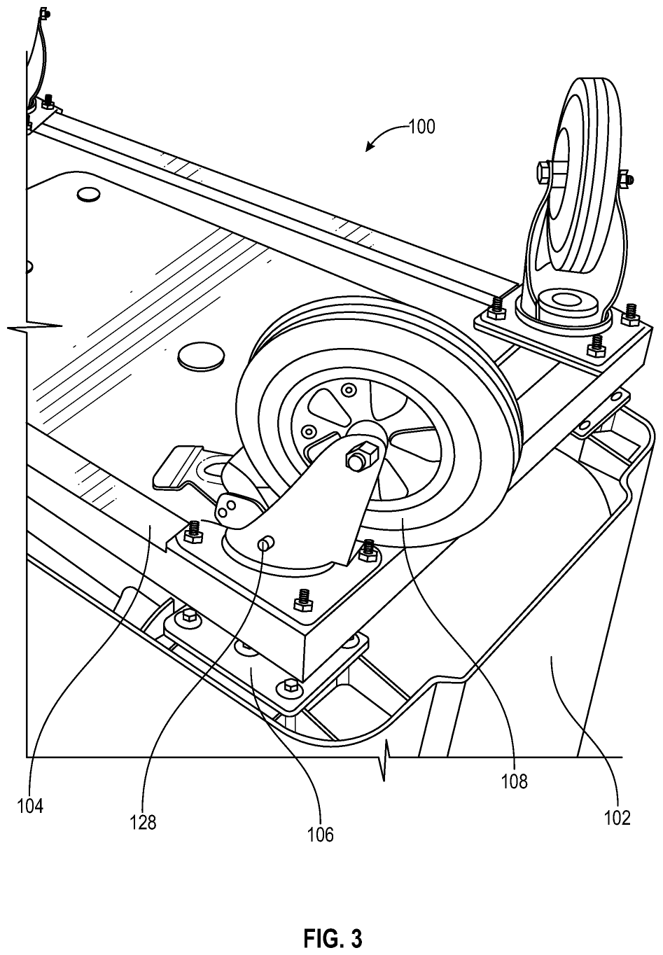

FIGS. 1, 2 and 3 show the apparatus (generally indicated by 100) according to a first preferred exemplary embodiment of the invention, attached to a waste bin (102), which in this embodiment is of the “wheeled” variety although this is not intended to be limiting.

In this embodiment, the waste bin (102) is a commercial or industrial-size waste bin. However, this is not intended to be limiting and the waste bin (102) may have a capacity of anywhere from 80 L to 6000 L.

In this embodiment, the waste bin (102) is a rear end lift bin—this will most often be the case in commercial premises, due to space limitations and overhead obstructions, which rear end lift bins are best adapted for. However, the waste bin (102) may be of any other suitable type.

The waste bin (102) may be designated for any type of waste—e.g. food organics, paper and cardboard, recycling, commingle (mixed recycling), general waste, e-cycle (e-waste), or shredded paper et cetera.

The waste bin (102) may be fitted with a lock (not shown) such that only authorized parties (possessing a key or code) have access to, and are able to deposit matter into, the waste bin (102). The lock (not shown) and the key (not shown) may be fitted with (or otherwise associated with) identification means, such as RFID or keypad technology, such that each “deposit event”, i.e. instance of depositing of matter into the bin, can be tracked to a particular authorized party. This is advantageous as it allows the building operations manager to charge tenants and other relevant parties in proportion to the amount of waste they have actually deposited in the waste bin (102) in a given period of time.

In this embodiment, the retaining means of the apparatus is provided by a frame (104). However, this is not intended to be limiting, and it is within the scope of the invention for the retaining means of the apparatus to be configured differently—for instance, the retaining means may alternatively be provided by a base plate, or by fastening means associated with the load cells and rigidly connecting the load cells to the base of the waste bin (102). Other configurations for the retaining means are also possible, and are within the scope of the invention. For convenience, the following discussion refers to the retaining means being a frame (104): however, this is not to be taken as limiting.

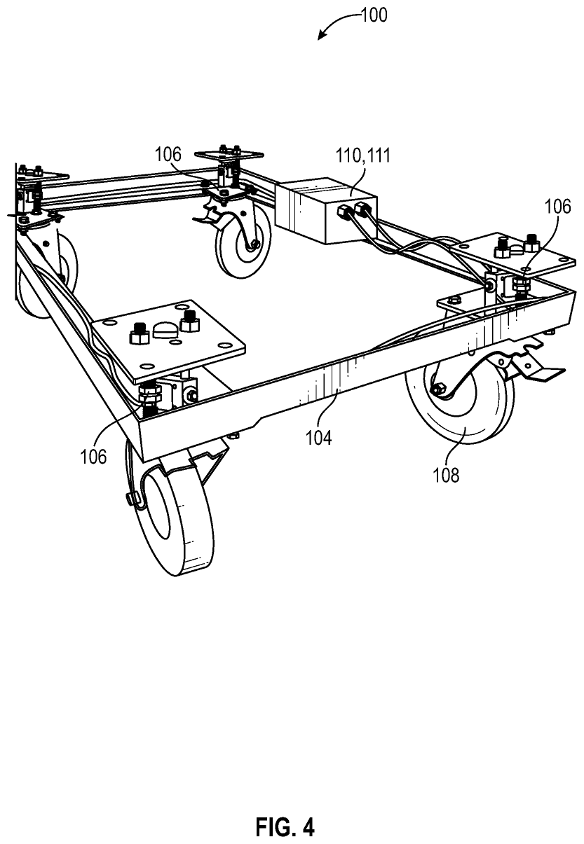

The apparatus comprises a plurality of load cells (106—shown in greater detail in FIGS. 4, 5, 6A & 6B), each of which is rigidly connected to the frame (104).

It can be seen that a portion of the bin (102) bears directly down on each load cell (106). More specifically, in this embodiment the frame (104) is configured and dimensioned such that it approximately matches the “footprint” of the base of the bin (102). This is preferable, although variations are also within the scope of the invention, for example it is possible for the bin to extend some way beyond the frame, i.e. to “overhang” the frame. More generally, the frame can be configured and dimensioned so as to be suitable for use with any required bin size, and any applicable standards. For instance, in Australia, the AS 4123 standard prescribes maximum dimensions for various kinds of waste bins, as well as colour-coding to indicate the type of waste a particular bin is designated for: the frame (104) of the invention can be configured to accord with this standard.

As best seen in FIGS. 4, 5, 6A & 6B, in this embodiment the frame (104) is configured with an L-shaped cross-section, having a sidewall portion (104A) and a horizontal portion (104B). In this embodiment the frame (104) is formed from steel and has a thickness of substantially 3 mm. However, other suitable materials, cross-sections, and configurations are also within the scope of the invention. The advantage of the particular design and configuration discussed herein is that only a single frame (104) of relatively simple and cost-effective design is required to mount the apparatus (100) to the bin (102), including to accommodate the load cells (106) in such a manner that they are held rigidly in place and the bin (102) rests on top of them, and also to accommodate the wheels (108) in the manner discussed below.

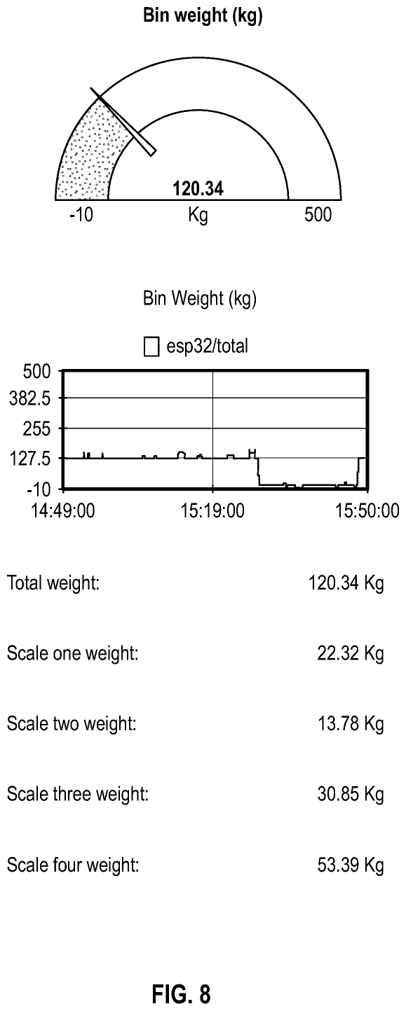

In this embodiment, there are four load cells (106)—one disposed at each corner of the frame (104). Positioning the load cells (106) at the corners of the frame (106) is preferred as it allows them to be sturdily secured on two sides by the frame (104), in the manner discussed below. It is also preferred as it gives an indication of weight distribution within the bin, as seen in FIG. 8. However, this is not intended to be limiting, and other configurations are possible. For instance, in other embodiments the cells (106) might instead be disposed—preferably substantially regularly—at other points around the frame (104), such as midway along each of its sidewalls. There may be more or fewer than four cells (106). The cells (106) might even be disposed on the exterior, rather than the interior, of the frame (106), notably in embodiments where the bin is to overhang the frame in use. The skilled person may envisage other variations falling within the scope of the invention.

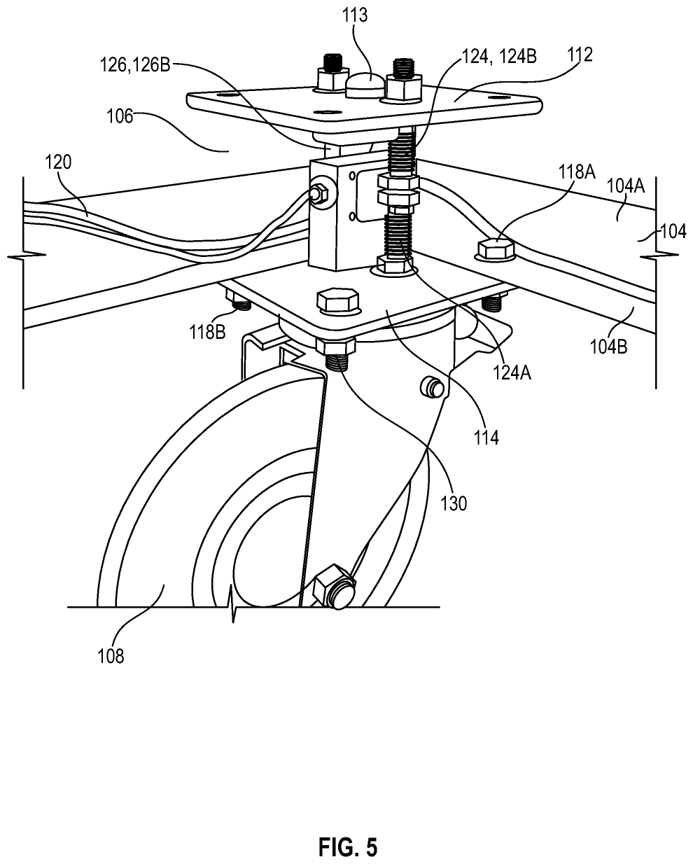

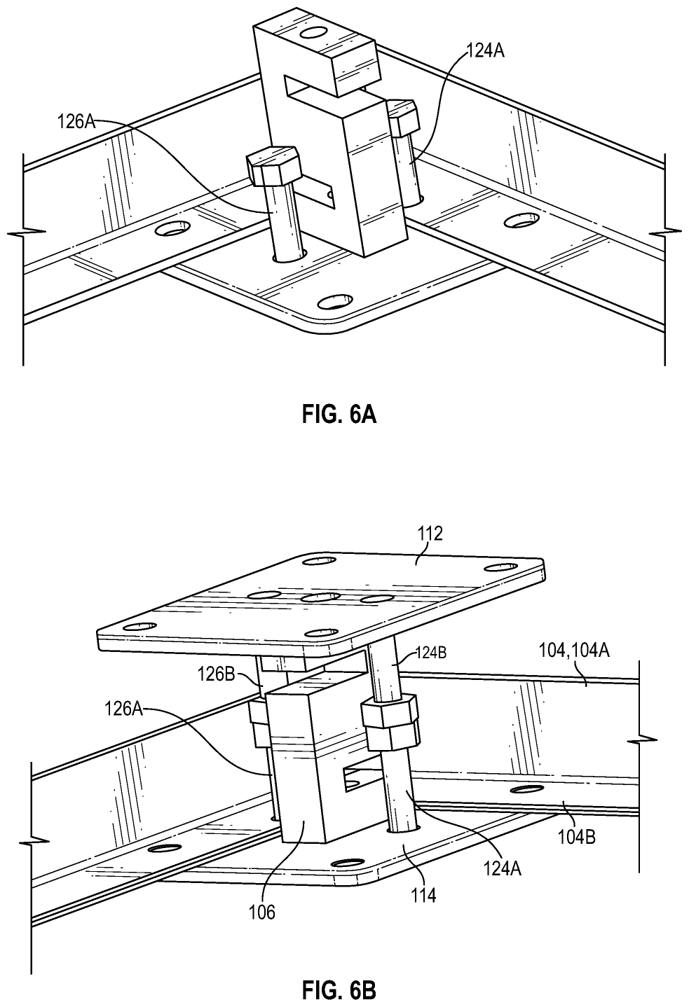

The specific configuration of the load cells (106) (and ancillary components) of this embodiment is best seen in FIGS. 5, 6A and 6B. Each load cell (106) is associated with an upper plate (112) and a lower plate (114) at, respectively, the upper and lower end of the load cell (106). The plates (112, 114) in this embodiment are identical in their design, although this is not intended to be limiting. In this embodiment the load cell (106) is bolted (113) to the upper and lower plate (112, 114), although other connection means are possible. For convenience, the load cell (106) and upper and lower plate (112, 114) are in places referred to in the singular hereinafter.

The lower plate (114) is rigidly connected to the horizontal portion (104B) of the frame (104) (in this case via welding, though other connection means are possible), thus effecting a rigid and sturdy connection of the load cell (106) to the frame (104). A rigid and sturdy connection of the load cell (106) to the frame (104) is advantageous in that it means the load cells (106) only experience vertical loading, and are not subjected to torque. This allows the load cells (106) to be of relatively simple and cost-effective design, and also means the data generated by the load cells (106) is less complex with less post-processing required.

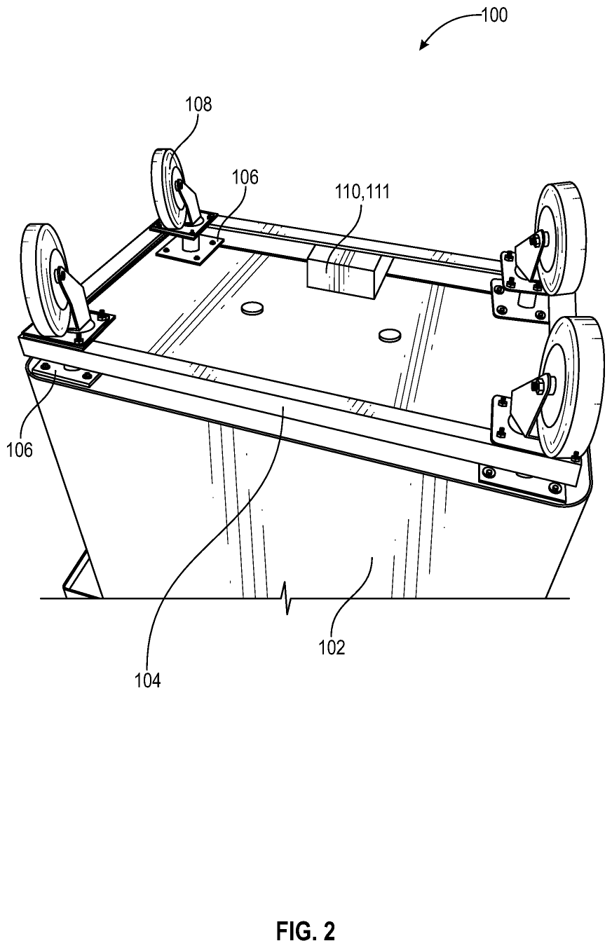

The upper plate (112) is configured to be connected to the base of the bin, in this embodiment via bolting to existing contouring (wheel attachment regions) at the corners of the underside of the bin as seen in FIG. 2. However, this is not intended to be limiting. Other connection means are possible: alternatively, it is even possible for the bin to not be connected to the upper plates (112) at all, but rather simply to rest on them in use. This may be less desirable as it would mean the waste bin would come away from the frame when elevated for emptying, and would then need to be placed back on the frame: however, it is nonetheless within the scope of the invention.

More generally, the invention is not intended to be limited to this particular configuration. For instance, it is within the scope of the invention for the load cell (106), in appropriate cases, to be rigidly connected directly to the frame (104), in particular the horizontal portion (104B) of the frame (104), such that the lower plate (114) is omitted altogether. Other variations falling within the scope of the invention may be envisaged by the skilled person.

In this embodiment, the load cells (106) are strain gauge load cells, and more particularly S-type load cells. Accordingly, the load cells (106) extend above the sidewall portion (104A) of the frame, to enable the load cells (106) to deform when subjected to loading, and more generally to ensure the applied load is borne by the load cells (106) as opposed to the frame (104).

S-type load cells are particularly well suited for use in the present invention in that they are well adapted to compressive loading of the type the waste bin will impose, and also are relatively low-cost and simple in their design. S-type load cells comprise an internal coil (“strain gauge”) which is compressed upon compressive loading of the load cell, decreasing its resistance and thus increasing the voltage output and thereby allowing applied load to be determined. In this embodiment, output from the load cells is communicated to a control unit (110) via electrical wiring (120).

The inventors have experimentally found the “Zemic H3 nickel plated S-type load cell” to be particularly suitable for use in the present invention. This brand of load cell carries an IP67 rating, meaning it is resistant to particulate matter and has a degree of water resistance, making it robust against the often harsh waste management environment. However, this is not intended to be limiting and other brands/types of S-type load cells (or other types of strain gauge load cells, or even other types of load cells altogether, such as hydraulic or pneumatic load cells) may be suitable for use in the present invention.

In this embodiment, each of the load cells (106) is associated with limiting means configured to prevent the load cell from being subjected to excessive deformation, that is to say, deformation that goes beyond the compressive load the load cell (106) is designed for. In this particular embodiment, the maximum deformation is 0.2 mm, but this will vary depending on the configuration and tolerance of the specific load cell.

The limiting means is provided by a pair of limit member assemblies (124, 126), spaced on either side of the load cell (106) in a symmetrical manner. In this embodiment, the limit member assemblies (124, 126) are limit bolt assemblies, comprising a lower limit bolt (124A, 126A) connected to the lower plate (114), and an upper limit bolt (124B, 126B) connected to the upper plate. However, this is not intended to be limiting and other types of limit member may instead be used—for instance, threaded stoppers.

Each pair of lower (124A, 126A) and upper (124B, 126B) limit bolts is spaced such that, when the load cell (106) is in an unloaded condition, the spacing between their respective heads corresponds to the maximum allowable deformation of the load cell (106) in use. Thus, when this limit is reached, the heads of the pairs of limit bolts will come into contact with one another, preventing further deformation of the load cell (106).

In this embodiment, the apparatus (100) is configured for use in conjunction with a wheeled waste bin. More particularly, in this embodiment the apparatus (100) has been retrofitted to a waste bin (102) having existing wheels (108). This has been achieved by detaching the wheels (108) from the base of the waste bin (102) and inserting the apparatus (100) between the base of the waste bin (102) and the wheels (108). To this end, the lower plates (114) interface with and are connected to the existing mounting plates (128) of the wheels, which previously were directly connected to the base of the bin (102). In this embodiment, the connection is effected via bolts (118A, 118B, 130), although other connection means are possible.

However, variations on the above-discussed configuration of the wheel connections are possible.

More generally, the invention is not limited to being used with (or retrofitted to) bins of the specific variety shown in FIG. 1. The apparatus (100) may also be used with MGBs (“wheelie bins”) of the smaller, domestic-type style, having a capacity of e.g. 120 L, 140 L or 240 L. This may potentially require certain modifications, e.g. the wheels may need to be disposed somewhat lower than usual to enable the apparatus (100) on the underside of the bin to clear the ground when the bin is inclined backward for rolling (or alternatively a user may need to incline the bin more than usual). The apparatus (100) may also be used with non-wheeled bins, wherein the frame rests directly on the ground. Alternatively, the apparatus (100) may have pre-installed wheels, for use with otherwise non-wheeled bins. The skilled person may envisage other applicable variations falling within the scope of the invention.

In this embodiment, the apparatus (100) includes a means for recording and transmitting data from the load cells (106), which is provided by the control unit (110) which is rigidly mounted to the frame (104). The control unit (110) is communicable with the load cells (106) via suitable electrical wiring (120), such that the load cells (106) may at predetermined intervals transmit data relating to applied load.

In this embodiment, the control unit (100) comprises an IP66-rated exterior enclosure (111) formed from polycarbonate (due to that material's robustness and resistance to the types of chemicals typically used for cleaning waste bin environments). However, other materials may also be suitable.

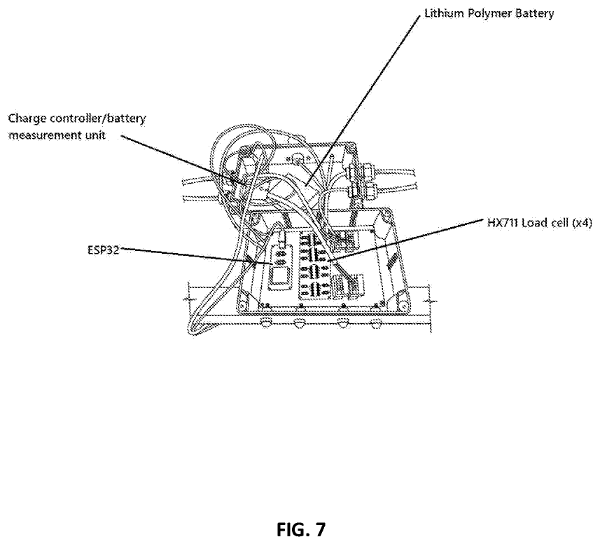

As seen in FIG. 7, the control unit (110) of this embodiment comprises four HX711 load cell amplifiers, an ESP32 to handle data and wireless communications to a receiver (not shown), a lithium polymer battery to power the unit and a charge module to control/measure the battery voltage. In use, the HX711 send an excitation voltage to the load cells, which return a varying voltage based on the loading of the cells. They then output a voltage, that the ESP can interpret as a weight based on a library defined for the HX711. However, variations on the depicted embodiment are possible. For instance, the control unit may be provided as or by a single printed circuit board (PCB). Other types of electronic components besides those mentioned above may also be used.

In use, the control unit (110) receives load data, in the form of voltage readings, from the load cells (106) at predetermined recording intervals. These intervals can be set by the individual user of the apparatus (100), such as a building operations manager of the premises at which the waste bin (102) is located. The desired intervals will depend on the user's requirements and preferences. For instance, they may be set at once a day if relatively infrequent monitoring is sufficient for that particular location. Alternatively, they may be set much more frequently, e.g. once an hour or even once a minute, if the user desires to maintain detailed real-time awareness of the bin's loading, for instance to detect particular bin users (such as building tenants) who dispose of waste irresponsibly or inappropriately. Experimentally, the inventors have found that 5-minute recording intervals are particularly suitable.

However, this is not intended to be limiting. A variation falling within the scope of the invention is for the apparatus (100) to include an accelerometer (or other suitable device; not shown) associated with the load cells (106) and configured to detect when matter is deposited in the waste bin (102), such as by detecting a sudden increase in the rate of vertical movement of the load cells (106). In this variation, the “predetermined recording interval” is contingent on an event determined by the accelerometer, namely the detection of matter being deposited in the waste bin (102). In other words, the apparatus (100) may be configured to “snooze” when no activity is detected, and to “wake”, and obtain load data, when a deposit event is detected by the accelerometer—the occurrence of the deposit event being the “predetermined recording interval”.

Once received, the control unit (110), specifically the ESP, converts the voltage data into weight (mass) data. The inventors have found that the apparatus (100) and system of the present invention enables relatively very accurate weight (mass) data to be obtained—experimentally, in 10 g increments and with a 0.5% margin of error; a significant improvement on truck-mounted weighing systems which tend to record weight in 5 kg increments.

For completeness, it should be noted that in this embodiment, the control unit (110) and/or the load cells (106) are calibrated such that the weight (mass) of the empty bin (102) itself is not included in the ultimate weight (mass) data. This is so that the weight (mass) data reflects only the contents of the waste bin (102), which is the information the relevant parties need to know.

At predetermined transmission intervals, the control unit (110) transmits the weight (mass) data to a receiver (not shown). Again, the transmission intervals can be set to the user's requirements, for instance once per hour, once per day, or once per week; it is preferable for transmission to be less frequent than recording, to conserve battery power of the control unit (110). Experimentally, the inventors have found that once-daily transmission intervals are particularly suitable, especially when combined with the 5-minute recording intervals. Using these intervals, the apparatus of this embodiment may require charging of the battery as infrequently as once every 6 months.

In this embodiment, the data is transmitted in a CSV file format, via a wireless Internet connection. However, this is not intended to be limiting and suitable variations may be envisaged.

In some embodiments, it is also possible for the control unit (110) to comprise means for accounting for periods of compromised transmission, for instance when Internet is not available. For example, the control unit (110) may be configured to, if transmission is compromised at the predetermined transmission interval/time, automatically transmit the data as soon as transmission once gain becomes available: or alternatively to transmit the “untransmitted” data at the next predetermined transmission interval/time, together with the successive “batch” of data.

The receiver (not shown) is communicable with, or integrated with, a personal electronic device, such as a smartphone or laptop, of one or more users. The receiver is configured to enable the transmitted data to be displayed on the personal electronic device—an example of this is shown in FIG. 8. It is also within the scope of the invention for the data display to be integrated with existing software used to monitor other parameters of the premises, such as electricity and water consumption, such that the building operations manager is able to view bin data (in addition to other building parameters) via a single portal.

It is also within the scope of the invention for the control unit (110) to directly transmit the data to the personal electronic device of the one or more users, i.e. without first transmitting to a distinct receiver. The skilled person will envisage suitable variations and modifications.

The one or more users/recipients of the transmitted data will typically include the building operations manager, and may also include the waste management supplier. Accordingly, it will be appreciated that the system of the present invention enables automatic collection and transmission of waste bin weight data—at intervals selected to suit the user(s)—without any additional manoeuvring of bins or other effort. All interested parties are able to receive highly accurate, real-time (or at least regular) data relating to bin weight. This facilitates compliance by building operations managers with applicable environmental regulations/incentives/policies, and also allows them to monitor and pinpoint (such as in conjunction with CCTV footage) any “problem areas”, such as individuals disposing of excessive waste or the wrong type of waste, as well as to identify peak waste-disposal times for the premises, and any other relevant information/trends.

From the waste management service's perspective, the accurate, real-time data gives them the option of quoting for waste removal based on weight, as opposed to bin size/capacity. This will tend to minimise downstream problems to do with discrepancies between the quote given and the amount subsequently charged by the landfill provider or MRF.

There may be numerous other recipients of the transmitted data, such as tenants, building owners, government bodies, local councils, environmental bodies, and regulatory/oversight bodies. Examples in Australia include, without limitation, NABERS, GRESB, BBP, and WELL.

Accordingly, the invention provides a simple, cost-effective, flexible solution that can be customized and fitted (or retrofitted) to bins of any size and type, and that provides all interested parties with highly accurate, regular bin weight data, and is thereby advantageous in numerous respects to the respective parties.

### Testing

The above-described preferred exemplary embodiment was confidentially subjected to testing between 19 Oct. 2021 and 21 Oct. 2021. Graphs 1 and 2 below show, respectively, weight data recorded and transmitted by the system over the full test period and over the latter 24-hour period. The graphs are similar to the data which, in preferred embodiments of the invention, may be displayed to the at least one prespecified recipient.

Graph 1, at the left-hand side, shows the predetermined data-recording intervals being varied from 5 seconds (initially) to 20 minutes (thereafter).

Graph 2 shows in more detail the latter 24 hours, demonstrating the accuracy and sensitivity of the system, and its ability to record and show precisely when particular loading activity occurred in respect of the waste bin.

The first portion of Graph 2 shows the load cells picking up on oscillation-related loading of the bin during transportation. An accuracy demonstration was then performed, whereby the bin was first inverted (to show the load cells reacting to tensile loading), and then was subjected to various loads up to substantially 80 kg to demonstrate the accuracy/sensitivity of the load cells. After a period of standing empty, the data shows the bin being loaded, then remaining loaded for a period before being emptied.

It will of course be realized that while the foregoing has been given by way of illustrative example of this invention, all such and other modifications and variations thereto as would be apparent to persons skilled in the art are deemed to fall within the broad scope and ambit of this invention as is hereinbefore described.

If any reference numeral(s) is/are used in a claim or claims then such reference numeral(s) should not be considered as limiting the scope of that respective claim or claims(s) to any particular embodiment of the drawings.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. it will be taken to mean an inclusion of not only the listed components it directly references, but also other non-specified components or elements. This rationale will also be used when the term ‘comprised’ or ‘comprising’ is used in relation to one or more steps in a method or process.

1-23. (canceled)

24. An apparatus configured to, in use, detect a weight of a wheeled waste bin, the apparatus comprising:
a plurality of load cells rigidly retained, in use. relative to the waste bin by one or more retaining means,
wherein said retaining means is provided by a frame, said plurality of load cells being rigidly connected, in use, to the frame, wherein each of the plurality of load cells is associated with a lower plate connected to a lower end of the load cell and configured to, in use, be rigidly connected to the frame by being fastened to the frame via a connection means. and an upper plate connected to an upper end of the load cell and configured to, in use. support a portion of the bin, wherein each of the lower plates is configured to, in use, be connected to a mounting plate of a wheel or wheel castor of the bin
wherein the apparatus is configured and dimensioned such that, in use. a portion of the bin is disposed substantially above, and bears down on, each of the plurality of load cells:
wherein the apparatus is fitted, in use, between the base of the wheeled waste bin and the wheels of the wheeled waste bin.
wherein the apparatus is configured to, in use. be communicable with means for recording and transmitting data from the plurality of load cells,
wherein said means for recording and transmitting data is configured to record the data at predetermined recording intervals, and to transmit the recorded data at predetermined transmission intervals, wherein the predetermined recording intervals are one of the following:
between substantially every 1 minute to substantially every 24 hours; substantially every 1 hour;
or substantially every 5 minutes; and wherein the predetermined transmission intervals are one of the following: between substantially every 1 hour to substantially once per week: or substantially every 24 hours.

25. The apparatus of claim 24, wherein the frame is substantially square or rectangular and is configured and dimensioned to be dimensionally substantially complementary to a base of the waste bin.

26. The apparatus of claim 24, wherein the frame has a substantially L-shaped cross-section comprising a sidewall portion extending substantially vertically and a horizontal portion extending inwardly from a lower edge of the sidewall portion.

27. The apparatus of claim 24, wherein the plurality of load cells are spaced, in use, substantially regularly relative to the frame.

28. The apparatus of claim 26, wherein the plurality of load cells are disposed, in use, at the corners of the L-shaped frame, and are supported on two sides by the orthogonal horizontal portions at the corners of the L-shaped frame.

29. The apparatus of claim 24, wherein the load cells are strain gauge load cells.

30. The apparatus of claim 29, wherein the load cells are S-type load cells.

31. The apparatus of claim 29, wherein each of the load cells is, in use, associated with limiting means configured to prevent the load cell from being subjected to excessive deformation, said limiting means being provided by a limit member assembly comprising an upper limit member and a lower limit member, wherein, in use, the upper and lower limit member are arranged such that a gap between them defines a maximum deformation of the load cell.

32. The apparatus of claim 24. wherein the predetermined recording intervals and/or predetermined transmission intervals are selectively alterable by a user.

33. The apparatus of claim 24, wherein the means for recording and transmitting data is configured to transmit the recorded data to a receiver, said receiver being communicable with. or integrated with, an electronic device of at least one prespecified recipient of the transmitted data, to enable the transmitted data to be displayed to said at least one prespecified recipient.

34. The apparatus of claim 24, wherein the means for recording and transmitting data from the plurality of load cells is connected, in use, to the frame.

35. The apparatus of claim 24, wherein the waste bin is fitted with a lock such that only authorized parties possessing a key have access to. and are able to deposit matter into, the waste bin; wherein the lock and the key are fitted with, or associated with. identification means, such that each “deposit event” can be tracked to a particular authorized party.

36. A system for detecting and managing data relating to a weight of a wheeled waste bin, the system comprising:
an apparatus for detecting the weight of the waste bin, said apparatus comprising a plurality of load cells rigidly retained, in use, relative to the waste bin by one or more retaining means; wherein said retaining means is provided by a frame, said plurality of load cells being rigidly connected, in use, to the frame, wherein each of the plurality of load cells is associated with a lower plate connected to a lower end of the load cell and configured to. in use, be rigidly connected to the frame by being fastened to the frame via a connection means, and an upper plate connected to an upper end of the load cell and configured to, in use, support a portion of the bin, wherein each of the lower plates is configured to, in use, be connected to a mounting plate of a wheel or wheel castor of the bin; wherein the apparatus is configured and dimensioned such that, in use, a portion of the bin is disposed substantially above, and bears down on. each of the plurality of load cells: wherein the apparatus is fitted, in use, between the base of the wheeled waste bin and the wheels of the wheeled waste bin, means for recording and transmitting data from the plurality of load cells of said apparatus, wherein said apparatus is configured to, in use, be communicable with said means:
and a receiver for receiving data transmitted from said means, said receiver being communicable with. or integrated with, an electronic device of at least one prespecified recipient. to enable the transmitted data to be displayed to said at least one prespecified recipient wherein said means for recording and transmitting data is configured to record the data at predetermined recording intervals. and to transmit the recorded data at predetermined transmission intervals, wherein the predetermined recording intervals are one of the following:
between substantially every 1 minute to substantially every 24 hours; substantially every 1 hour;
or substantially every 5 minutes: and wherein the predetermined transmission intervals are one of the following: between substantially every 1 hour to substantially once per week: or substantially every 24 hours.

37. A method of detecting and managing data relating to a weight of a wheeled waste bin, using:
an apparatus for detecting the weight of the waste bin. said apparatus comprising a plurality of load cells rigidly retained, in use, relative to the waste bin by one or more retaining means; wherein said retaining means is provided by a frame, said plurality of load cells being rigidly connected. in use, to the frame, wherein each of the plurality of load cells is associated with a lower plate connected to a lower end of the load cell and configured to, in use, be rigidly connected to the frame by being fastened to the frame via a connection means, and an upper plate connected to an upper end of the load cell and configured to, in use. support a portion of the bin, wherein each of the lower plates is configured to, in use. be connected to a mounting plate of a wheel or wheel castor of the bin; wherein the apparatus is configured and dimensioned such that, in use, a portion of the bin is disposed substantially above, and bears down on. each of the plurality of load cells: wherein the apparatus is fitted, in use. between the base of the wheeled waste bin and the wheels of the wheeled waste bin:
means for recording and transmitting data from the plurality of load cells of said apparatus, wherein said apparatus is configured to, in use, be communicable with said means: and
a receiver for receiving data transmitted from said means, said receiver being communicable with, or integrated with, an electronic device of at least one prespecified recipient, to enable the transmitted data to be displayed to said at least one prespecified recipient,
the method comprising the steps of:
at predetermined recording intervals, recording data from the plurality of load cells;
at predetermined transmission intervals, transmitting the recorded data to the receiver:
displaying the transmitted data on the electronic device of the at least one prespecified recipient'
wherein the predetermined recording intervals are one of the following: between substantially every 1 minute to substantially every 24 hours; substantially every 1 hour; or substantially every 5 minutes; and wherein the predetermined transmission intervals are one of the following: between substantially every 1 hour to substantially once per week; or substantially every 24 hours.

38. The apparatus of claim 24, wherein the transmission intervals are less frequent than the recording intervals.

39. The apparatus of claim 38 wherein the recording intervals are substantially every 5 minutes, and the transmission intervals are substantially every 24 hours.

40. The apparatus of claim 24, wherein the apparatus includes an accelerometer associated with the load cells and configured to detect when matter is deposited in the waste bin.

41. The apparatus of claim 40, wherein the apparatus is configured to detect when matter is deposited in the waste bin by detecting a sudden increase in the rate of vertical movement of the load cells.

42. The apparatus of claim 24, wherein the waste bin has a capacity (i.e. volume to which it is designed to be filled) of substantially one of: 360 L; 660 L; 1000 L (1 m³); 1100 L (1.1 m²); 1500 L (1.5 m³); 2000 L (2 m³); 3000 L (3 m³); 4500 L (4.5 m³); or 6000 L (6 m³).

43. The apparatus of claim 28, wherein the load cells provide an indication of weight distribution within the bin.
